(19) United States
(12) Patent Application Publication
(10) Pub. No.: US 2023/0136889 A1
(43) Pub. Date: May 4, 2023

(54) FINE-GRAINED CONCEPT IDENTIFICATION FOR OPEN INFORMATION KNOWLEDGE GRAPH POPULATION

(71) Applicant: NEC Laboratories Europe GmbH, Heidelberg (DE)

(72) Inventors: Markus Zopf, Heidelberg (DE); Kiril Gashteovski, Heidelberg (DE)

(21) Appl. No.: 17/572,685

(22) Filed: Jan. 11, 2022

Related U.S. Application Data
(60) Provisional application No. 63/273,187, filed on Oct. 29, 2021.

(51) Int. Cl. G06F 40/284; G06F 40/205; G06N 5/02

(52) U.S. Cl. CPC G06F 40/284; G06F 40/205; G06N 5/02

(57) ABSTRACT

A method and system for performing natural language processing is provided to populate improved knowledge graphs. The technique for populating a knowledge graph includes: parsing a text document to extract one or more sentences from the text document; for each sentence in the one or more sentences, identifying a set of concept candidates for the sentence; for each concept candidate in the set of concept candidates, obtaining zero or more compound modifier children of the concept candidate; for each concept candidate and the corresponding compound modifier children, adding a first node to the knowledge graph corresponding to the concept candidate and at least one additional node to the knowledge graph corresponding to the compound modifier children; and adding relations to the knowledge graph to associate the first node with the at least one additional node.

### CROSS-REFERENCE TO RELATED APPLICATIONS

This application claims the benefit of U.S. Patent Application No. 63/273,187, filed on Oct. 29, 2021, which is incorporated by reference herein in its entirety.

### FIELD

The present disclosure relates to natural language processing. More specifically, the present disclosure relates to population of knowledge graphs for performing open information extraction.

### BACKGROUND

Knowledge graphs (KGs) are a popular method to model relational knowledge. Consequently, KGs can be applied in a wide range of applications. However, manually creating KGs is time consuming and costly. Automatic KG generation aims at automatically generating KGs without manual effort.

Open information extraction (OIE) refers to a method to extract information triples (usually subject-verb-object triples) from natural language sentences such as “red meat has a high concentration of saturated fatty acids” such that the extracted triples can be inserted into a KG. However, existing systems that use OIE to populate KGs extract the full text span describing subjects, verbs, and objects, such as “red meat” and “saturated fatty acid” (e.g., OpenIE, OpenIE5.1 and OpenIE6), or only extract a minimal concept, such as “meat” and “acid” (e.g., MinIE).

OpenIE is described by Angeli et al., “Leveraging Linguistic Structure For Open Domain Information Extraction,” In Proceedings of the Association of Computational Linguistics (ACL), P15-2034 (2015), which is incorporated by reference herein in its entirety. OpenIE5.1 is described by a combination of :CALMIE (extraction from conjunctive sentences), as described in Saha et al., “Open Information Extraction from Conjunctive Sentences,” COLING 2018; BONIE (extraction from numerical sentences), as described in Saha et al., “Bootstrapping for Numerical OpenIE,” ACL 2017; RelNoun (noun relations extraction), as described in Pal et al., “Demonyms and Compound Relational Nouns in Nominal OpenIE,” Workshop on Automated Knowledge Base Construction (AKBC) at NAACL 2016; and SRLIE (semantic role labeling), as described in Christensen et al., “An Analysis of Open Information Extraction based on Semantic Role Labeling,” KCAP 2011, each of which is incorporated by reference herein in their entireties. OpenIE6 is described by Kolluru et al., “OpenIE6: Iterative Grid Labeling and Coordination Analysis for Open Information Extraction,” arxiv preprint 2010.03147, which is incorporated by reference herein in its entirety. MinIE is described by Gashteovski et al., “MinIE: Minimizing Facts in Open Information Extraction,” EMNLP, ACL anthology D17-1278 (2017), which is incorporated by reference herein in its entirety.

FIG. 1 illustrates the extracted triples obtained by these methods, in accordance with the prior art. Output A exemplifies the output of a method extracting the full text span such as in OpenIE, OpenIE5.1 and OpenIE6. Output A includes a subject clause (“red meat”), a verb clause (“has a high concentration of”), and an object clause (“saturated fatty acids”), each clause containing one or more tokens. Output B exemplifies the output of a minimal extraction such as MinIE. Output B includes a subject clause (“meat”), a verb clause (“has a high concentration of”), and an object clause (“acids”), where the clauses may omit certain modifier tokens.

A major disadvantage of the methods for extracting the full text span describing subjects is a low connectivity in the resulting KGs since these methods (e.g., OpenIE, OpenIE5.1, and OpenIE6) consider each extraction as atomic and are not able to make connections between two different sub-concepts that share a common super-concept. For instance, no relation between “saturated fatty acid” and “unsaturated fatty acid” can be created within the KG. On the other hand, the methods extracting a minimal concept (e.g., MinIE) extract only a part of the information and may thus over-generalize information. For instance, a text that talks about acids in general and a text that talks about unsaturated fatty acid specifically cannot be distinguished since the method extracts in both cases only the super-concept “acid”. Furthermore, this extraction strategy can lead to incorrect extractions. For instance, the sentence “polyunsaturated fatty acids are known to be healthy” would result in the triple ‘acids’—‘are known to be’—‘healthy’, which is not the information expressed by the text in the best case or simply incorrect in the worst case.

### SUMMARY

According to a first aspect of the present disclosure, a method for populating a knowledge graph is provided. The method includes: parsing a text document to extract one or more sentences from the text document; for each sentence in the one or more sentences, identifying a set of concept candidates for the sentence; for each concept candidate in the set of concept candidates, obtaining zero or more compound modifier children of the concept candidate; for each concept candidate and the corresponding compound modifier children, adding a first node to the knowledge graph corresponding to the concept candidate and at least one additional node to the knowledge graph corresponding to the compound modifier children; and adding relations to the knowledge graph to associate the first node with the at least one additional node.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an exemplary input and the resulting output from existing OIE systems, in accordance with the prior art;

FIG. 2 illustrates an exemplary input and the resulting output from an OIE system, in accordance with an embodiment of the present disclosure;

FIG. 3 illustrates two exemplary input sentences and the resulting output from an OIE system, in accordance with an embodiment of the present disclosure;

FIG. 4 schematically illustrates a method and system for outputting an improved and more complete KG, in accordance with an embodiment of the present disclosure;

FIG. 5 illustrates (sub-) concept detection and node creation/connection, in accordance with an embodiment of the present disclosure;

FIG. 6 illustrates a method for populating a knowledge graph, in accordance with an embodiment of the present disclosure; and

FIG. 7 illustrates a system for implementing the method of FIG. 6, in accordance with an embodiment of the present disclosure.

### DETAILED DESCRIPTION

The embodiments of the present disclosure provide a method, system and computer-readable medium to improve the quality of KGs used for OIE by identifying atomic concepts and implied concept hierarchies in a natural language text. As a result, embodiments of the present disclosure are able to achieve highly connected and correct extractions. In contrast, existing systems are only able to obtain low connectivity in the resulting KGs and/or extract imprecise/incorrect extractions.

Embodiments of the present disclosure provide a solution to the technical problems of the existing systems by splitting multi-word concepts into a concept hierarchy, for automatic KG generation. As used herein, the term “multi-word concepts” refers to a collection of two or more tokens associated with a general concept such as “saturated fatty acid” and that are not named-entities (NEs) such as “New York”. Embodiments of the present disclosure are able to identify root concepts, which are general concepts such as “acid” or “meat” that are not generalized further. Different systems can be used to detect root concepts. For instance, in an embodiment, part-of-speech tags in a dependency tree can be used to identify root concepts. An alternative embodiment may implement a machine learning model to predict for each token whether the token is a root concept. The identified root concepts become concept candidates (CCs), which can be filtered in an optional next step.

For each CC, additional fine-grained concepts (i.e., sub-concepts) are identified. This can again be performed with a dependency tree or a machine learning model that has been trained for this purpose. The identified root concepts and sub-concepts are then added to the KG. More specifically, each root concept and each sub-concept is added as new node to the KG unless nodes for the root concepts and/or sub-concepts are already contained in the KG. Additionally, connections (i.e., relations) between root concepts and their corresponding fine-grained sub-concepts are created. After the root concepts and fine-grained sub-concepts have been added to the KG, different variants of OIE can be utilized to extract OIE triples from the original sentences.

According to a first aspect of the present disclosure, a method is provided for populating a knowledge graph. The method includes the steps of: parsing a text document to extract one or more sentences from the text document; for each sentence in the one or more sentences, identifying a set of concept candidates for the sentence; for each concept candidate in the set of concept candidates, obtaining zero or more compound modifier children of the concept candidate; for each concept candidate and the corresponding compound modifier children, adding a first node to the knowledge graph corresponding to the concept candidate and at least one additional node to the knowledge graph corresponding to the compound modifier children; and adding relations to the knowledge graph to associate the first node with the at least one additional node. Each sentence includes a plurality of tokens.

In an embodiment according to the first aspect, identifying the set of concept candidates for the sentence comprises identifying part-of-speech tags for each token in the sentence based on a dependency tree. In another embodiment according to the first aspect, identifying the set of concept candidates for the sentence comprises processing the sentence with a machine learning model to obtain the set of concept candidates.

In an embodiment according to the first aspect, the method further comprises filtering the set of concept candidates to remove at least one concept candidate from the set.

In an embodiment according to the first aspect, the method further comprises filtering the zero or more compound modifier children to remove any compound modifier children that are identified by a part-of-speech (POS) tag as being an adverb.

In an embodiment according to the first aspect, the method further comprises, for each sentence in the one or more sentences, extracting an information triple based on an OIE algorithm.

In an embodiment according to the first aspect, the method further comprises adding relations to the knowledge graph based on the information triple.

In an embodiment according to the first aspect, the method further comprises storing the knowledge graph in a memory; or transmitting the knowledge graph over a network.

In an embodiment according to the first aspect, a service available over the network is configured to query the knowledge graph to identify relevant documents in a set of text documents.

According to a second aspect of the present disclosure, a system for performing natural language processing is provided to populate improved knowledge graph. The system includes a storage device storing one or more text documents and at least one processor. The at least one processor is configured to generate a knowledge graph by: parsing a text document to extract one or more sentences from the text document; for each sentence in the one or more sentences, identifying a set of concept candidates for the sentence; for each concept candidate in the set of concept candidates, obtaining zero or more compound modifier children of the concept candidate; for each concept candidate and the corresponding compound modifier children, adding a first node to the knowledge graph corresponding to the concept candidate and at least one additional node to the knowledge graph corresponding to the compound modifier children; and adding relations to the knowledge graph to associate the first node with the at least one additional node.

In an embodiment according to the second aspect, identifying the set of concept candidates for the sentence comprises identifying part-of-speech tags for each token in the sentence based on a dependency tree. In another embodiment according to the second aspect, identifying the set of concept candidates for the sentence comprises processing the sentence with a machine learning model to obtain the set of concept candidates.

In an embodiment according to the second aspect, the at least one processor is further configured to filter the set of concept candidates to remove at least one concept candidate from the set.

In an embodiment according to the second aspect, the at least one processor is further configured to filter the zero or more compound modifier children to remove any compound modifier children that are identified by a part-of-speech (POS) tag as being an adverb.

In an embodiment according to the second aspect, the at least one processor is further configured to, for each sentence in the one or more sentences, extract an information triple based on an OIE algorithm.

In an embodiment according to the second aspect, the at least one processor is further configured to add relations to the knowledge graph based on the information triple.

In an embodiment according to the second aspect, the at least one processor is further configured to store the knowledge graph in a memory; or transmit the knowledge graph over a network.

In an embodiment according to the second aspect, a service available over the network is configured to query the knowledge graph to identify relevant documents in a set of text documents.

According to a third aspect of the present disclosure, a non-transitory computer-readable media is provided for storing computer instructions for generating a knowledge graph. The instructions, responsive to being executed by one or more processors, cause the one or more processors to perform the method according to the first aspect.

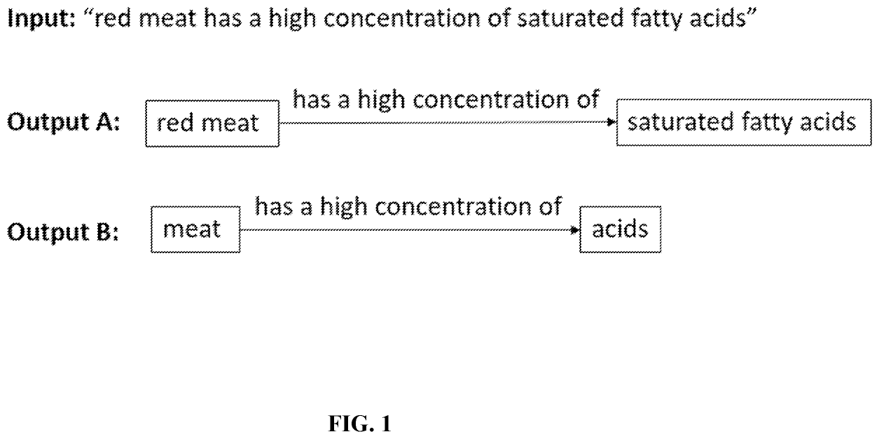

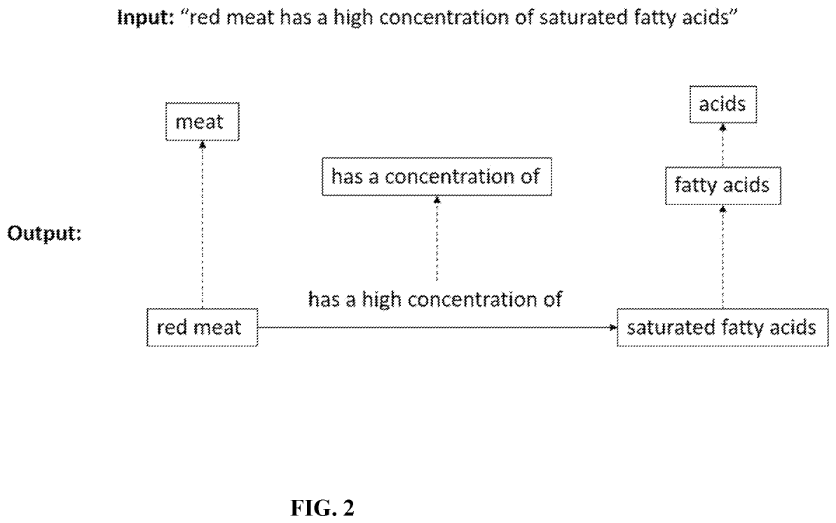

FIG. 2 illustrates an improved output of the system for the input sentence “red meat has a high concentration of saturated fatty acids” (compared to the output of existing systems in FIG. 1). As shown in FIG. 2, the subject of the sentence (i.e., “red meat”) corresponds with a first node for the root concept (i.e., “meat”) and a second node for the sub-concept (i.e., “red meat”). Further, there is a connection (i.e., relation) added to the KG that associates the sub-concept with the root concept. Nodes for root concepts and sub-concepts for the verb and object clauses are also shown in FIG. 2. In general, a multi-word concept containing a number of tokens may include compound modifiers, which are one or more tokens that describe a noun. In the example shown in FIG. 2, red, high, and unsaturated fatty are compound modifiers for the nouns meat, concentration, and acids, respectively. A root concept may include a clause with tokens identified as compound modifiers omitted therefrom. Similarly, a sub-concept may comprises a root concept with one or more tokens from a compound modifier added to the root concept. In general, when a compound modifier includes multiple tokens, then each token may represent a different sub-concept, where one, two, three, or more tokens are added to the root concept to form the sub-concept. Each sub-concept can be connected in the KG to a root concept or sub-concept comprising a smaller number of tokens.

Embodiments of the present disclosure are able to combine the advantages of both full text extraction and minimized extraction above since application of the methods leads to a high connectivity in the resulting KGs and correct extractions at the same time. The proposed method obtains correct extractions since it does not remove tokens from the extracted span (i.e., it does not perform overgeneralization). The obtained high connectivity can be illustrated when the embodiments of the present disclosure are applied to a second sentence such as “red meat has a low concentration of beneficial polyunsaturated fatty acids”.

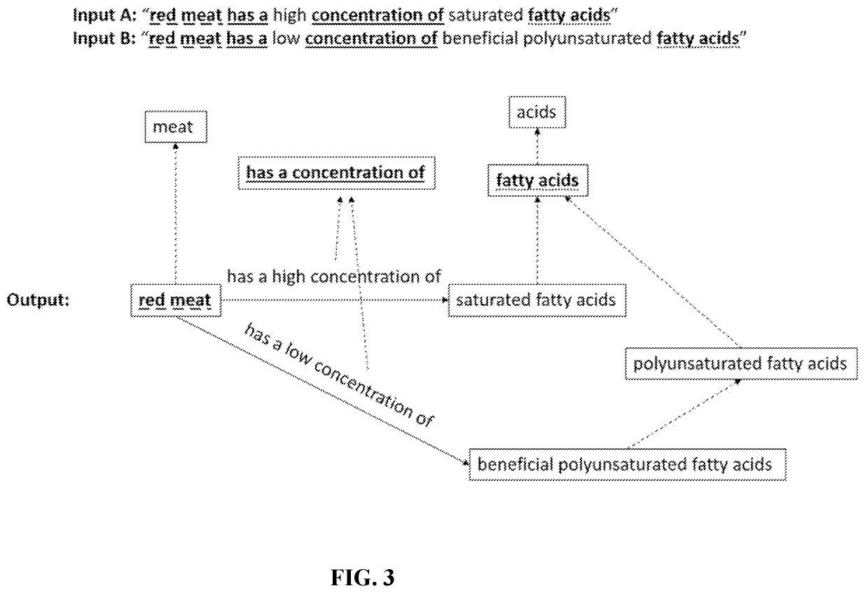

FIG. 3 shows how the application of the method and system according to embodiments of the present disclosure leads to a highly connected KG. A KG based on both Input A (“red meat has a high concentration of saturated fatty acids”) and Input B (“red meat has a low concentration of beneficial polyunsaturated fatty acids”) includes a node “fatty acid” that has a connection to the object clause of both Input A and Input B. The existing systems would not be able to create a node ‘fatty acid’ and would not create a connection between the two OIE objects. Hence, a user interested in “fatty acids” can easily retrieve relevant nodes, sentences, and documents without using any additional tool such as (potentially learned) a similarity measure for text spans.

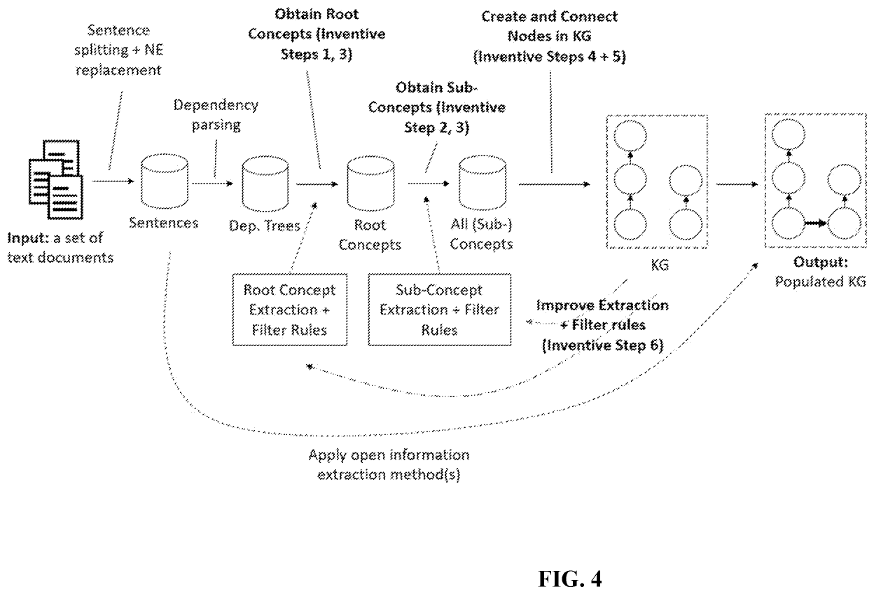

FIG. 4 schematically illustrates a system for KG construction, in accordance with an embodiment of the present disclosure. In particular, FIG. 4 illustrates a set of text documents that is obtained as input to the system. A processing module parses the set of text documents to split each document into constituent sentences. In addition, the processing module may optionally remove or replace named entities in the text documents.

For each sentence, the processing module performs dependency parsing to generate dependency trees for the sentence. A dependency tree is a data structure (i.e., a tree), where the token representing the verb is the root of the tree and all other tokens of the sentence are connected, either directly or indirectly, to the root node based on dependency relation. It will be appreciated that analyzing each token to identify a part-of-speech (POS) of the token may be necessary to determine the structure of the dependency tree.

Once the dependency tree is constructed, the dependency tree is utilized to obtain a set of concept candidates associated with the sentence. To this end, a dependency tree can be used to identify relevant the part-of-speech (POS) tags such as NN (Noun, singular or mass), NNS (Noun, plural), NNP (Proper noun, singular), and NNPS (Proper noun, plural). The POS associated with each token, along with the tokens' positions in the dependency tree can be used to identify the set of concept candidates. In an embodiment, a filter can be applied to limit the number of concept candidates. For instance, concept candidates that are named entities (NEs), part of a conjunction, and/or sub-parts of a compound noun can be filtered since none of these will be a proper root-concept (i.e., a concept that has no super-concept). The specific implementation of the filter can be adapted individually.

For each concept candidate, the processing module extracts zero or more sub-concepts. Again, sub-concepts can include, in addition to the tokens of the concept candidate, additional compound modifiers having one or more tokens. Sub-concepts can be identified using the dependency tree. In an embodiment, a filter can be applied to limit the number of sub-concepts. For example, in an embodiment, a rule can specify that all adverbs are ignored and, thus, the addition of an adverb to a compound modifier does not result in a new sub-concept.

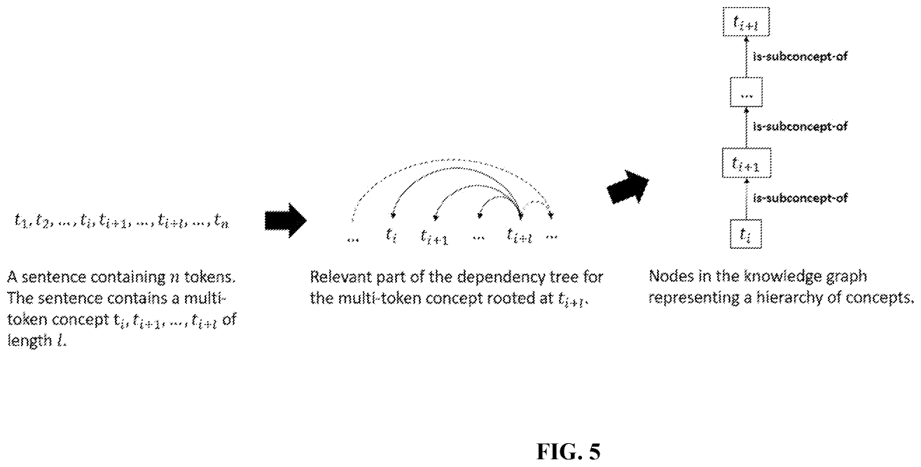

Once the root concept candidates and sub-concepts are identified for the sentence, a KG can be improved by adding nodes to the KG for each root concept candidate and each sub-concept, unless the nodes are already included in the KG, for example, based on the processing of other sentences in the current text document or a prior text document. A relation (i.e., a connection) is added between each root concept candidate node and each corresponding sub-concept node, either directly or indirectly when more than one sub-concept is related to a particular root concept. Consequently, a chain of relations is obtained for multi-token concepts. For instance, as shown in FIG. 5, for a multi-token concept tᵢ, tᵢ+1, . . . , tᵢ₊₁, a chain of relations tᵢ→tᵢ₊₁, tᵢ₊₁→tᵢ₊₂, . . . , t₍ₗ₋₁₎→tₗ is added to the KG.

Finally, the OIE is performed on the original sentences in order to extract OIE triples for the original sentences. Relations corresponding to the OIE triples are then added to the KG. It will be appreciated that the relations from the concept candidates and sub-concepts plus the relations from the OIE create a more robust and connected KG.

In an embodiment, if reference data is available, the extraction and/or filter rules can be automatically improved iteratively. For instance, reference data can be a manually created KG, which represents the expected output KG for an input sentence. Based on the reference data, an error score is computed that measures the discrepancy between the generated output and the reference data. Multiple methods to compute the discrepancy between two KGs already exist. In a simple scenario, precision and recall of nodes in the generated KG can be computed with respect to the nodes in the reference KG. More complex methods, for instance based on a graph edit distance, can be used as well to compute an error score. Extraction and/or filter rules are then added, modified, and/or deleted such that fewer incorrect entries in the KG are created and more missing entries are created.

As an alternative for using a dependency tree for root- and sub-concept identification is the implementation of supervised or unsupervised machine learning models to extract concept candidates or sub-concepts. To this end, a wide range of machine learning models can be used. For instance, neural networks can be trained to detect concept candidates and/or sub-concepts. In this case, a dataset is used in which concept candidates and/or sub-concepts are annotated and the neural network is trained to correctly predict the label of each token. In this case, tokens are often represented by a vector representation that is either pre-trained or jointly trained while learning to predict the concept candidates and/or sub-concepts. Examples of neural networks that have been used for similar tasks are RNNs, LSTMs, and, more recently, Transformer networks. In this case, no extra pre-processing such as POS tagging or dependency parsing is required. In other embodiments, a combination of techniques can also be used. For instance, a set of extractions can be obtained via pre-specified rules which can be used to train a supervised machine learning model.

In an embodiment, the present disclosure provides for knowledge graph population for advanced text analysis. Natural language texts such as scientific publications or news articles contain huge amounts of useful information. However, the information cannot be used by other technical systems and humans easily as long as the information is stored in unstructured text documents. For instance, a project that aims at analyzing the knowledge about genes and proteins and their effects on phenotypes such as plant growth or meat quality has high interest in collecting all information that is contained in unstructured scientific documents to store it in a structured knowledge graph. However, current OIE methods fail to create densely connected KGs that only contain correct information as explained above, which limits the usefulness of the generated KG.

Embodiments of the present disclosure improve the quality of the KG and thus improves the usefulness of the structured data that is stored in the KG. The generated KG can be used by other technical systems to provide improvements in those systems, and by humans. For instance, KGs are used by automatic text summarization systems and automatic question answering systems. Embodiments of the present disclosure will improve these technical systems, and other technical systems, by improving the quality and the usefulness of the KG. Furthermore, training and testing of machine learning systems are also able to be improved by application of embodiments of the present disclosure because the KG will contain more connections and more precise concept nodes. Using KGs is not necessarily limited to be used by other technical systems, but can also be inspected and used for other purposes by humans.

As mentioned above, the generated KG can be used by an automatic question answering system to generate answers for questions. In this case, the question answering system would use the KG as a graph database. By extending the example mentioned above, a question answer system could use the generated KG to retrieve all types of “acid” that have been extracted from natural language text. The proposed techniques allow for retrieval of this information, since the information is already properly stored in the KG and is easy to retrieve. An automatic text summarization service can use the generated KG to generate a textual summary of an input document or a set of input documents. In this case, the techniques disclosed herein would be used to generate a KG of one or multiple documents. Then, the summarization system would use the KG to retrieve the most important information triples from the KG and would automatically generate a textual summary that contains a subset of the information that has been stored in the KG.

In an embodiment, the methods disclosed herein can be applied for retrieving relevant documents. Retrieving relevant documents covering specific topics is an important problem in many domains. For instance, researchers, journalists, and software developers frequently have to read many scientific documents, journalistic articles, or software bug descriptions to identify relevant text documents, which is very time consuming. Embodiments of the present disclosure can be used to analyze the text documents to create a KG of all documents in a text collection. The KG can then be queried by other technical systems for further analysis. For instance, a recommender system can be trained on the KG, which will then be able to make document recommendations. Embodiments of the present disclosure improve the quality of the KG by introducing additional nodes and links between nodes, which has a positive effect to the recommender system.

In an embodiment, the methods disclosed herein can be applied for collaboration recommendation/team building. Finding people or a group of people with a specific knowledge or skill set is an important problem in many areas. Examples include researchers who want to identify a set of people who can provide feedback for a paper/proposal draft or journalists who want to find a colleague with background knowledge on a specific topic. Embodiments of the present disclosure can be used to scan the documents a person reads/writes to generate a digital repository of his/her knowledge/expertise. The constructed digital repository can improve the output of subsequent systems such as collaboration recommender systems. Since embodiments of the present disclosure add more nodes, and more different kinds of nodes, and more connections to the KG than existing systems, the recommender system can return more appropriate results. Furthermore, the repository or a set of repositories can also be queried by end-users to obtain recommendations.

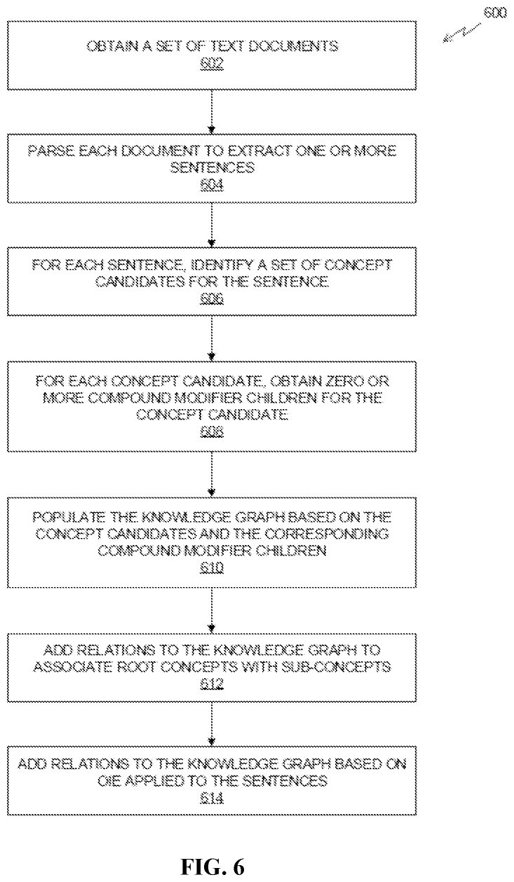

FIG. 6 illustrates a method 600 for fine-grained concept identification for populating a knowledge graph, in accordance with an embodiment of the present disclosure. The method 600 can be performed by a system configured to process text documents as described above using the techniques illustrated in FIG. 4. In an embodiment, the method 600 is performed by a computer system including one or more processors and a computer-readable storage medium (i.e., a memory) storing instructions and or data, including text documents provided as input to a processing module. The processing module may be implemented as software, firmware, hardware, or any combination of software, firmware or hardware.

At 602, a set of text document is obtained as input. The text documents are data structures or files containing representations of characters and/or tokens (e.g., words) in one or more natural languages (e.g., English, French, German, etc.).

At 604, each a text document is parsed (i.e., split) to extract one or more sentences from the text document. Each sentence includes a plurality of tokens. Any feasible technique for splitting a text document into a plurality of constituent sentences may be implemented in the method, including splitting the text document based on punctuation characters such as a period character or a semi-colon character. Optionally, at step 604, all named entities can be annotated or replaced such that the named entities can be filtered or removed from each of the sentences.

At 606, for each sentence in the one or more sentences, a set of concept candidates is identified for the sentence. In an embodiment, a dependency parser is applied to obtain a dependency tree for each sentence. The dependency tree is then utilized to identify the set of concept candidates based on POS tags included in the dependency tree and/or a position of each token in the dependency tree. In another embodiment, a machine learning model is applied to predict concept candidates within the sentence. Optionally, at step 606, a filter can be applied to limit the number of concept candidates that are identified.

At 608, for each concept candidate in the set of concept candidates, zero or more compound modifier children are obtained for the concept candidate. In an embodiment, the compound modifier children can be identified based on the dependency tree. In another embodiment, a machine learning model can be utilized to predict the compound modifier children for each concept candidate. Optionally, at 608, a filter can be applied to limit the number of compound modifier children that are identified.

At 610, a KG is populated based on the set of concept candidates and the corresponding compound modifier children. In an embodiment, for each concept candidate and corresponding compound modifier children, a first node is added to the knowledge graph for a root concept corresponding to the concept candidate and at least one additional node is added to the knowledge graph for one or more sub-concepts corresponding to the compound modifier children.

At 612, relations are added to the knowledge graph to associate the first node with the at least one additional node. The relations added in step 612 associate each root concept, either directly or indirectly, with one or more sub-concepts.

At 614, relations are added to the KG based on an OIE algorithm (e.g., OpenIE, OpenIE5.1, OpenIE6, MinIE) applied to the original sentences. The relations added based on OIE tie certain root concepts and/or sub-concepts to other root concepts and or sub-concepts to form OIE triples. The relations from step 612 plus the relations from step 614 create a more robust KG than formed by conventional techniques. In an embodiment, the KG may be output and/or stored in a memory and used for a variety of applications.

As described above, embodiments of the present disclosure are able to achieve a KG that is more densely connected, which improves its usability. Generating only sparsely connected KGs is a key limitation of existing systems, which inherently limits their practical relevance and applicability to various technical systems. Furthermore, as opposed to existing systems, the KG constructed according to embodiments of the present disclosure will not contain incorrect overgeneralization. Hence, the constructed KG according to embodiments of the present disclosure will be more useful and more reliable. Additionally, embodiments of the present disclosure can be combined with many existing systems for OIE to improve those technical systems as well. Embodiments of the present disclosure can used to improve systems that automatically construct KGs to improve the quality of the resulting KGs.

In particular, existing systems either focus on extracting complex triples from natural language text, extracting standalone hypernym relations between nouns or considering stand-alone minimization of extractions without any applications to KGs. In contrast, embodiments of the present invention are able to provide to continuously update the KG by refining the concepts to more fine-grained sub-concepts, while at the same time populating it with new triples.

In an embodiment, the present invention assumes that for an expression of the form ‘x y’ (e.g. with x=‘fatty’ and y=‘acid’), ‘y’ is a super-concept of ‘x y’, i.e. all ‘x y’ are a specific type of ‘y’. Practical experience shows that this assumption is usually true in natural language texts. One situation could be, for example, the expression “couch potato” is an example. An embodiment of the present invention will split these kinds of expressions into two concepts and will assume that the text talks about ‘potato’ and that ‘couch potato’ is a sub-concept of ‘potato’. This relatively minor issue which does not typically arise in practice could be prevented, however, according to an embodiment of the present disclosure, by using a manually curated dictionary of atomic multi-word concepts to prevent a split in this case. Another method to mitigate this issue would be to generate a dictionary with data-driven methods. However, as already indicated above, practical experience shows that this issue would not have a large impact in practice.

In some cases that include conjunctions, it may not be possible to identify sub-concepts based on the syntax of the sentence. For instance, in the conjunction “beef and dairy cattle”, it is unclear if the phrase refers to ‘beef’ and ‘dairy cattle’ or to ‘beef cattle’ and ‘dairy cattle’. Such an ambiguity can be resolved in many cases by humans by applying common sense. In an embodiment, this issue is addressed by only extracting sub-concepts from the last (often the second) part of a conjunction.

In an embodiment, the system may also include an optional step of word sense disambiguation.

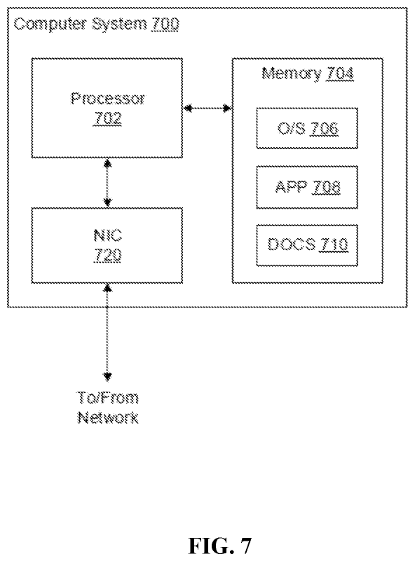

FIG. 7 illustrates an exemplary computer system 700, in accordance with some embodiments. The computer system 700 includes a processor 702, a non-volatile memory 704, and a network interface controller (NIC) 720. The processor 702 can execute instructions that cause the computer system 700 to implement the functionality various elements of the OIE system described above.

Each of the components 702, 704, and 720 can be interconnected, for example, using a system bus to enable communications between the components. The processor 702 is capable of processing instructions for execution within the system 700. The processor 702 can be a single-threaded processor, a multi-threaded processor, a vector processor or parallel processor that implements a single-instruction, multiple data (SIMD) architecture, or the like. The processor 702 is capable of processing instructions stored in the volatile memory 704. In some embodiments, the volatile memory 704 is a dynamic random access memory (DRAM). The instructions can be loaded into the volatile memory 704 from a non-volatile storage, such as a Hard Disk Drive (HDD) or a solid state drive (not explicitly shown), or received via the network. In an embodiment, the volatile memory 704 can include instructions for an operating system 706 as well as one or more applications 708. It will be appreciated that the application(s) can be configured to provide the functionality of one or more components of the OIE system, as described above. The NIC 720 enables the computer system 700 to communicate with other devices over a network, including a local area network (LAN) or a wide area network (WAN) such as the Internet. In an embodiment, the knowledge graph may be output to a separate service available over a network. The service may implement other types of algorithms that utilize the knowledge graph,

In an embodiment, the volatile memory 704 may also store a document repository 710 that includes one or more text documents. Although not shown explicitly, the volatile memory 704 may also store one or more machine learning models.

It will be appreciated that the computer system 700 is merely one exemplary computer architecture and that the processing devices implemented in the OIE system can include various modifications such as additional components in lieu of or in addition to the components shown in FIG. 7. For example, in some embodiments, the computer system 700 can be implemented as a system-on-chip (SoC) that includes a primary integrated circuit die containing one or more CPU cores, one or more GPU cores, a memory management unit, analog domain logic and the like coupled to a volatile memory such as one or more SDRAM integrated circuit dies stacked on top of the primary integrated circuit dies and connected via wire bonds, micro ball arrays, and the like in a single package (e.g., chip). In another embodiment, the computer system 700 can be implemented as a server device, which can, in some embodiments, execute a hypervisor and one or more virtual machines that share the hardware resources of the server device.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the embodiments as claimed.

What is claimed is:

1. A method for populating a knowledge graph, the method comprising:
parsing a text document to extract one or more sentences from the text document, wherein each sentence includes a plurality of tokens;
for each sentence in the one or more sentences, identifying a set of concept candidates for the sentence;
for each concept candidate in the set of concept candidates, obtaining zero or more compound modifier children of the concept candidate;
for each concept candidate and the corresponding compound modifier children, adding a first node to the knowledge graph corresponding to the concept candidate and at least one additional node to the knowledge graph corresponding to the compound modifier children; and
adding relations to the knowledge graph to associate the first node with the at least one additional node.

2. The method of claim 1, wherein the identifying the set of concept candidates for the sentence comprises identifying part-of-speech (POS) tags for each token in the sentence based on a dependency tree.

3. The method of claim 1, wherein the identifying the set of concept candidates for the sentence comprises processing the sentence with a machine learning model to obtain the set of concept candidates.

4. The method of claim 1, further comprising filtering the set of concept candidates to remove at least one concept candidate from the set.

5. The method of claim 1, further comprising filtering the zero or more compound modifier children to remove any compound modifier children that are identified by a part-of-speech (POS) tag as being an adverb.

6. The method of claim 1, further comprising:
for each sentence in the one or more sentences, extracting an information triple based on an OIE algorithm.

7. The method of claim 6, further comprising:
adding relations to the knowledge graph based on the information triple.

8. The method of claim 7, further comprising:
storing the knowledge graph in a memory; or
transmitting the knowledge graph over a network.

9. The method of claim 8, wherein a service available over the network is configured to query the knowledge graph to identify relevant documents in a set of text documents.

10. A system, comprising:
a storage device storing one or more text documents; and
at least one processor configured to generate a knowledge graph by:
parsing a text document to extract one or more sentences from the text document, wherein each sentence includes a plurality of tokens;
for each sentence in the one or more sentences, identifying a set of concept candidates for the sentence;
for each concept candidate in the set of concept candidates, obtaining zero or more compound modifier children of the concept candidate;
for each concept candidate and the corresponding compound modifier children, adding a first node to the knowledge graph corresponding to the concept candidate and at least one additional node to the knowledge graph corresponding to the compound modifier children; and
adding relations to the knowledge graph to associate the first node with the at least one additional node.

11. The system of claim 10, wherein the identifying the set of concept candidates for the sentence comprises identifying part-of-speech (POS) tags for each token in the sentence based on a dependency tree.

12. The system of claim 10, wherein the identifying the set of concept candidates for the sentence comprises processing the sentence with a machine learning model to obtain the set of concept candidates.

13. The system of claim 10, wherein the at least one processor is further configured to filter the set of concept candidates to remove at least one concept candidate from the set.

14. The system of claim 10, wherein the at least one processor is further configured to filter the zero or more compound modifier children to remove any compound modifier children that are identified by a part-of-speech (POS) tag as being an adverb.

15. The system of claim 10, wherein the at least one processor is further configured to:
for each sentence in the one or more sentences, extract an information triple based on an OIE algorithm.

16. The system of claim 15, wherein the at least one processor is further configured to:
add relations to the knowledge graph based on the information triple.

17. The system of claim 16, wherein the at least one processor is further configured to:
store the knowledge graph in a memory; or
transmit the knowledge graph over a network.

18. The system of claim 17, wherein a service available over the network is configured to query the knowledge graph to identify relevant documents in a set of text documents.

19. A non-transitory computer-readable media storing computer instructions for generating a knowledge graph that, responsive to being executed by one or more processors, cause the one or more processors to perform the steps of:
parsing a text document to extract one or more sentences from the text document, wherein each sentence includes a plurality of tokens;
for each sentence in the one or more sentences, identifying a set of concept candidates for the sentence;
for each concept candidate in the set of concept candidates, obtaining zero or more compound modifier children of the concept candidate;
for each concept candidate and the corresponding compound modifier children, adding a first node to the knowledge graph corresponding to the concept candidate and at least one additional node to the knowledge graph corresponding to the compound modifier children; and
adding relations to the knowledge graph to associate the first node with the at least one additional node.

20. The non-transitory computer-readable media of claim 19, the steps further comprising:
for each sentence in the one or more sentences, extracting an information triple based on an OIE algorithm.
